(19) United States
(12) Patent Application Publication
(10) Pub. No.: US 2014/0293072 A1
(43) Pub. Date: Oct. 2, 2014

(54) APPARATUS AND METHOD FOR DETERMINING IMAGE DATA

(71) Applicant: ELECTRONICS AND TELECOMMUNICATIONS RESEARCH INSTITUTE, DAEJEON (KR)

(72) Inventors: Do Hyung KIM, Cheongwon-gun Chungcheongbuk-do (KR); Ho Won KIM, Seoul (KR); Seung Wook LEE, Daejeon (KR); Ki Nam KIM, Seoul (KR); Jin Sung CHOI, Incheon (KR); Bon Ki KOO, Daejeon (KR)

(73) Assignee: ELECTRONICS AND TELECOMMUNICATIONS RESEARCH INSTITUTE, DAEJEON (KR)

(21) Appl. No.: 14/178,721

(22) Filed: Feb. 12, 2014

(30) Foreign Application Priority Data
Mar. 28, 2013 (KR) 10-2013-0033766

(51) Int. Cl. H04N 5/232

(52) U.S. Cl. CPC H04N 5/23254
USPC 348/208.1

(57) ABSTRACT

An apparatus for determining image data is disclosed, the apparatus including an image data identifier to evaluate a state change resulting from blocking or opening of a sensor, and identify a stabilized state of image data of the sensor in an opened state, and an image data determiner to receive image data identified to be the stabilized state, and determine the received image data to be image data absent an occurrence of interference between the sensor and another sensor through an integrity assessment of the image data.

### CROSS-REFERENCE TO RELATED APPLICATION

This application claims the priority benefit of Korean Patent Application No. 10-2013-0033766, filed on Mar. 28, 2013, in the Korean Intellectual Property Office, the disclosure of which is incorporated herein by reference.

### BACKGROUND

1. Field of the Invention

The present invention relates to an apparatus for capturing image data, and more particularly, to an apparatus for determining image data that determines image data available for use from among sensors.

2. Description of the Related Art

A conventional method has been employing a plurality of sensors to obtain an area of image data greater than an area of image data obtainable by a single sensor. Here, the image data obtained by the plurality of sensors may include an object having a greater accuracy and a greater area of image data than those of the image data obtained from the single sensor.

However, when at least two sensors are applied to an identical space, the at least two sensors are inclined to cause mutual interference. In this instance, obtaining a portion or all of image data may be impossible due to such interference. Also, an issue of degradation in a resolution, an image quality, and the like, of the image data may arise due to the interference. Accordingly, in recent times, when at least two sensors or depth sensors exist, a synchronization mechanism may be used so as to avoid the mutual interference.

Nonetheless, providing the synchronization mechanism amongst the at least two sensors may pose a problem in that requirements, such as characteristics, prices, and the like, of apparatuses including sensors need to be met.

### SUMMARY

An aspect of the present invention provides an apparatus for capturing image data that minimizes interference between sensors in which a synchronization mechanism is not provided, and efficiently obtains image data having a high accuracy using a plurality of sensors.

Another aspect of the present invention also provides an apparatus for capturing image data that minimizes interference between sensors in which a synchronization mechanism is not provided, and greatly enhances a performance associated with obtaining image data of the sensors having the minimized interference when compared to a sensor in which interference occurs.

Still another aspect of the present invention also provides an apparatus for capturing image data that verifies a stabilized state of a sensor, verifies an integrity of obtained image data corresponding to the stabilized state, and determines the image data of which the integrity is verified to be meaningful image data available for use.

According to an aspect of the present invention, there is provided an apparatus for determining image data, the apparatus including an image data identifier to identify a stabilized state of image data of a sensor in an opened state, based on a state change resulting from blocking or opening of the sensor, and an image data determiner to receive the image data identified to be the stabilized state, and through an integrity assessment of the image data, determine the image data to be image data absent an occurrence of interference between the sensor and another sensor.

According to another aspect of the present invention, there is provided an apparatus for determining image data, the apparatus including an accuracy value receiver to receive, from a sensor, a value associated with an accuracy of image data of the sensor at predetermined intervals, an image data identifier to identify a stabilized state of the value associated with the accuracy identified to be the stabilized state, an image data receiver to receive image data corresponding to the value associated with the accuracy identified to be the stabilized state, and an image data determiner to determine the received image data to be image data absent an occurrence of interference between the sensor and another sensor, through an integrity assessment of the received image data.

According to still another aspect of the present invention, there is provided a method of determining image data, the method including identifying a stabilized state of a sensor in an opened state, based on a state change resulting from blocking or opening of the sensor, and receiving the image data identified to be the stabilized state, and through an integrity assessment, determining the received image data to be image data absent an occurrence of interference between the sensor and the other sensor.

According to yet another aspect of the present invention, there is provided a method of determining image data, the method including receiving, from a sensor, a value associated with an accuracy of image data of the sensor at predetermined intervals, identifying a stabilized state of the value associated with the accuracy of the image data in an opened state, based on a state change resulting from blocking or opening of the sensor, receiving image data corresponding to the value associated with the accuracy identified to be the stabilized state, and determining the received image data to be image data absent an occurrence of interference between the sensor and another sensor through the integrity assessment of the received image data.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an apparatus for determining image data according to an embodiment of the present invention;

FIG. 2 is a diagram illustrating a detailed configuration of an apparatus for determining image data according to an embodiment of the present invention;

FIG. 3 is a diagram illustrating a detailed configuration of an apparatus for determining image data according to another embodiment of the present invention;

FIG. 4 is a diagram illustrating a stabilized state according to an embodiment of the present invention;

FIG. 5 is a flowchart illustrating a method of determining image data according to an embodiment of the present invention; and

FIG. 6 is a flowchart illustrating a method of determining image data according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

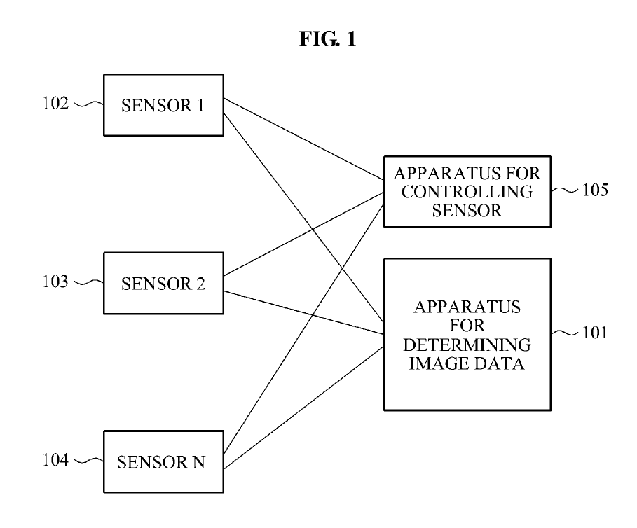

FIG. 1 is a diagram illustrating an apparatus 101 for determining image data according to an embodiment of the present invention.

Referring to FIG. 1, an apparatus 105 for controlling a sensor controls signals of a sensor 1 102, a sensor 2 103, and a sensor N 104, uses a control signal for controlling a sensor. In this example, the sensor 1 102, the sensor 2 103, and the sensor N 104 receive the control signal from the apparatus 105 for controlling the sensor via a signal blocker included in the plurality of sensors. Also, the control signal refers to a signal for controlling a blocked state and an opened state of a sensor. Further, the signal blocker may control the sensor, corresponding to the blocked and the opened state of the received control signal. In particular, the signal blocker may output a signal of the sensor, corresponding to the control signal associated with the blocked state received from the apparatus 105 for controlling the sensor. More particularly, the signal blocker may project a visible ray pattern, an infrared ray pattern, or the like, to obtain image data. Conversely, the signal blocker may input a signal of the sensor corresponding to the control signal associated with the opened state received from the apparatus 105 for controlling the sensor. In particular, the signal blocker may read a signal through which the visible ray pattern, the infrared ray pattern, or the like, projected to an object disposed in a space, is reflected. Additionally, the signal blocker refers to a physical device to be optically or mechanically blocked or opened. For example, the apparatus 105 for controlling the sensor may control a state change resulting from blocking or opening of the sensor in order to obtain the image data.

Also, the apparatus 101 for determining the image data controls the blocked state and the opened state of the sensor via the apparatus 105 for controlling the sensor with respect to a plurality of sensors in which a synchronization mechanism is not provided. For one example, among the plurality of sensors 102, 103 and 104, the apparatus 105 for controlling the sensor controls the sensor 1 102 to be in the opened state, and controls the sensor 2 103 and the sensor N 104 to be in the blocked state. The apparatus 101 for determining the image data receives image data with respect to the sensor 1 102 in the opened state. For example, the apparatus 105 for controlling the sensor controls the blocked state and the opened state of the plurality of sensors 102, 103, and 104 in a sequential order and thus, the apparatus 101 for determining the image data receives the image data for the plurality of sensors 102, 103, and 104.

The apparatus 101 for determining the image data recognizes the state change resulting from the blocking or opening of the sensor. In particular, the apparatus 101 for determining the image data recognizes a destabilized state or a stabilized state of the image data occurring in a process of the sensor being blocked and opened by the apparatus 105 for blocking the sensor. In this example, the apparatus 101 for determining the image data recognizes, from the sensor, the destabilized state or the stabilized state of the image data, using a value associated with an accuracy of the image data at predetermined intervals. Also, the apparatus 101 for determining the image data identifies the stabilized state of the image data, based on the value associated with the accuracy of the image data.

Further, the apparatus 101 for determining the image data receives the image data corresponding to the value associated with the accuracy identified to be the stabilized state.

In addition, the apparatus 101 for determining the image data determines the received image data to be image data, absent an occurrence of interference between the sensor and another sensor, through an integrity assessment of the image data.

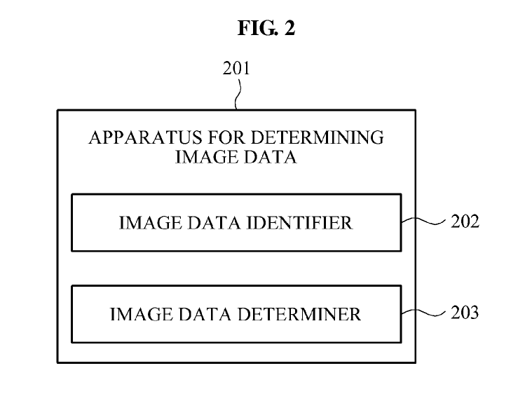

FIG. 2 is a diagram illustrating a detailed configuration of an apparatus 201 for determining image data according to an embodiment of the present invention.

Referring to FIG. 2, the apparatus 201 for determining the image data includes an image data identifier 202 and an image data determiner 203.

The image data identifier 202 identifies a stabilized state of image data of a sensor in an opened state, based on a state change resulting from blocking or opening of the sensor. In this example, the image data identifier 202 recognizes a destabilized state or stabilized state of the image data occurring in a process of the sensor being blocked or opened in order to obtain the image data of the sensor. In order to recognize the destabilized state or the stabilized state of the image data, the image data identifier 202 receives a value associated with an accuracy of the image data of the sensor, corresponding to an instance in which the sensor is blocked and opened. Here, the value associated with the accuracy of the image data includes a resolution of the image data, a frequency at which the image data is obtained, and the like.

Also, the image data identifier 202 identifies the stabilized state of the image data through the value associated with the accuracy of the image data being convergent with a predetermined value of the sensor. The predetermined value of the sensor refers to a value for identifying the stabilized state of the image data, and may be set to be differing predetermined values for a plurality of sensors. Further, the predetermined value of the sensor may be a value for verifying an availability for use of the image data based on a resolution, and the like, of the image data. For one example, when the predetermined value of the sensor is assumed to be “30”, the image data identifier 202 receives “25” as a value corresponding to the value associated with the accuracy of the image data. In addition, the image data identifier 202 determines whether the value associated with the accuracy is convergent with the predetermined value, based on the predetermined value of the sensor. Accordingly, the image data identifier 202 identifies the stabilized state of the image data, based on whether the value associated with the accuracy is convergent with the predetermined value.

The image data determiner 203 receives the image data identified to be the stabilized state. More particularly, the image data determiner 203 receives image data corresponding to the value associated with the accuracy of the image data identified to be the stabilized state. Also, the image data determiner 203 verifies an integrity using the received image data. In particular, the image data determiner 203 verifies the integrity of the received image data associated with whether interference occurs between the sensor and another sensor.

The image data determiner 203 verifies whether the received image data reaches the stabilized state, and is meaningful image data available for use. More particularly, the image data determiner 203 verifies an integrity of the image data identified to be the stabilized state via the image data identifier 202, and determines whether accurate image data, absent an occurrence of interference, corresponding to a signal projected to an object is obtained.

The image data determiner 203 verifies the integrity of the received image data, corresponding to a predetermined number of times. Also, the image data determiner 203 receives, from the sensor, differing image data identified to be the stabilized state when the integrity of the received image data is not verified. Further, the image data determiner 203 verifies the integrity, using the re-received image data.

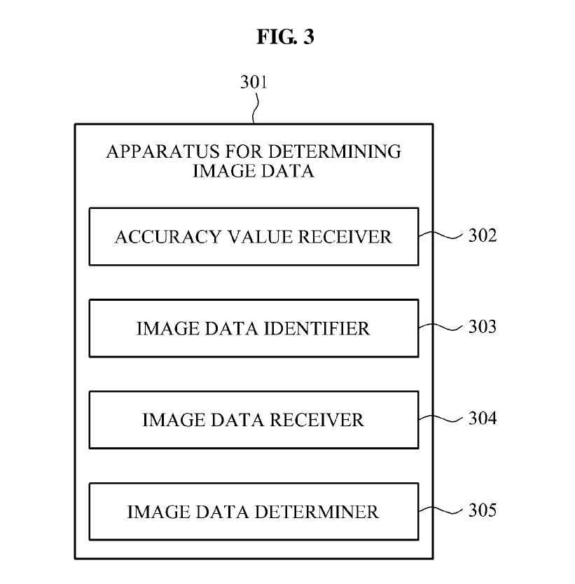

FIG. 3 is a diagram illustrating a detailed configuration of an apparatus 301 for determining image data according to another embodiment of the present invention.

Referring to FIG. 3, the apparatus 301 for determining the image data includes an accuracy value receiver 302, an image data identifier 303, an image data receiver 304, and an image data determiner 305.

The accuracy value receiver 302 receives, from a sensor, a value associated with an accuracy of image data. In this example, the accuracy value receiver 302 receives the value associated with the accuracy in order to identify a stabilized state of the image data. The value associated with the accuracy includes a resolution of image data, a frequency at which the image data is obtained, and the like. Also, the accuracy value receiver 302 receives, from the sensor, the value associated with the accuracy of the image data at predetermined intervals.

The image data identifier 303 evaluates a state change resulting from blocking or opening of the sensor, and identifies the stabilized state of the value associated with the accuracy of the image data in an opened state. More particularly, the image data identifier 304 identifies the stabilized state of the image data, corresponding to whether the value associated with the accuracy of the received image data is convergent with a predetermined value of the sensor.

In particular, the image data identifier 303 recognizes a destabilized state of the image data of the sensor, occurring due to blocking or opening of the sensor. Also, the image data identifier 303 recognizes the destabilized state of the image data, using a value associated with accuracy of image data continuously received via the accuracy value receiver 302, and using the value associated with the accuracy convergent with the predetermined value, identifies the stabilized state of the image data. Accordingly, the image data identifier 303 recognizes an instance in which the destabilized state of the image data changes to the stabilized state, using the value associated with the accuracy of the image data.

The image data receiver 304 receives image data corresponding to a value associated with an accuracy identified to be a stabilized state.

The image data determiner 305 determines the received image data to be image data absent an occurrence of interference between the sensor and another sensor through an integrity assessment of the received image data. The image data determiner 305 verifies an integrity of the received image data based on whether the interference occurs between the sensor and the other sensor. Also, the image data determiner 305 verifies the integrity of the received image data, corresponding to a predetermined number of times, and when the predetermined number of times is exceeded, receives differing image data identified to be the stabilized state. Further, the image data determiner 305 verifies the integrity of the received image data, using the re-received image data.

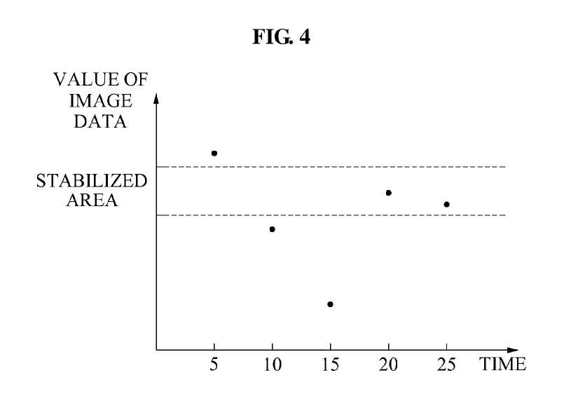

FIG. 4 is a diagram illustrating a stabilized state according to an embodiment of the present invention.

Referring to FIG. 4, an apparatus for determining image data receives, from a sensor, a value associated with an accuracy of image data of the sensor. In this example, the apparatus for determining the image data receives, from the sensor, the value associated with the accuracy of the image data at predetermined intervals. Also, the apparatus for determining the image data verifies whether the value associated with the accuracy of the received image data is convergent with a predetermined value of the sensor.

Here, the predetermined value of the sensor refers to a value associated with an accuracy of image data reaching a stabilized state of the image data. Accordingly, the apparatus for determining the image data identifies the image data corresponding to the value associated with the accuracy of the image data in the stabilized state when the value associated with the accuracy of the image data is convergent with the predetermined value. For one example, the apparatus for determining the image data verifies that values associated with an accuracy of image data received at 20 minutes and 25 minutes are convergent with a stabilized area, for example, predetermined values.

Also, the apparatus for determining the image data identifies a destabilized state of the image data using the value associated with the accuracy of the image data, verified not to be convergent with the predetermined value of the sensor. For one example, the apparatus for determining the image data recognizes that the image data is the destabilized state because values associated with an accuracy of image data received at 5 minutes, 10 minutes, and 15 minutes are not disposed in the stabilized area.

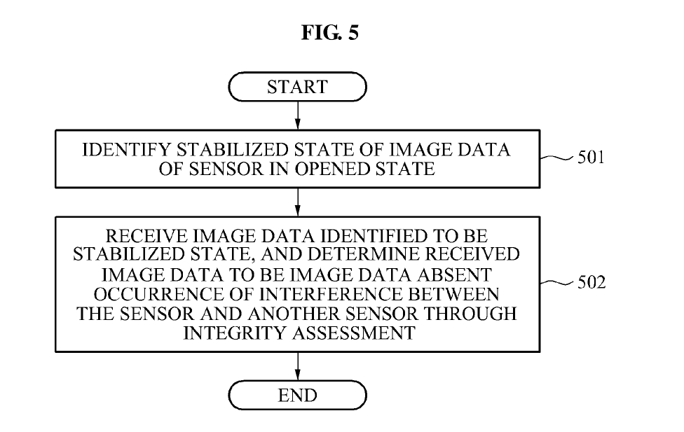

FIG. 5 is a flowchart illustrating a method of determining image data according to an embodiment of the present invention.

In operation 501, an apparatus for determining image data recognizes a destabilized state or a stabilized state of image data occurring in a process of a sensor being blocked or opened in order to obtain the image data of the sensor. More particularly, when a blocked state of the sensor changes to an opened state, the apparatus for determining the image data determines whether a value associated with an accuracy of image data input from the sensor, and identifies the destabilized state or the stabilized state of the image data.

In operation 502, the apparatus for determining the image data receives image data corresponding to a value associated with an accuracy of the image data identified to be the stabilized state. Also, the apparatus for determining the image data verifies an integrity of the received image data associated with whether interference between the sensor and another sensor occurs. More particularly, the apparatus for determining the image data verifies the integrity, using image data received from one of a plurality of sensors in which a synchronization mechanism is not provided. The synchronization mechanism may solve the interference issue occurring in the image data of the plurality of sensors when the plurality of sensors is simultaneously connected to a single threshold area corresponding to an object. For example, the apparatus for determining the image data verifies whether the received image data is in the stabilized state, and is meaningful image data available for use.

Also, the apparatus for determining the image data verifies the integrity of the received image data, corresponding to a predetermined number of times. Further, the apparatus for determining the image data receives, from the sensors, differing image data identified to be the stabilized state when the integrity of the received image data is not verified. The apparatus for determining the image data verifies the integrity using the re-received image data.

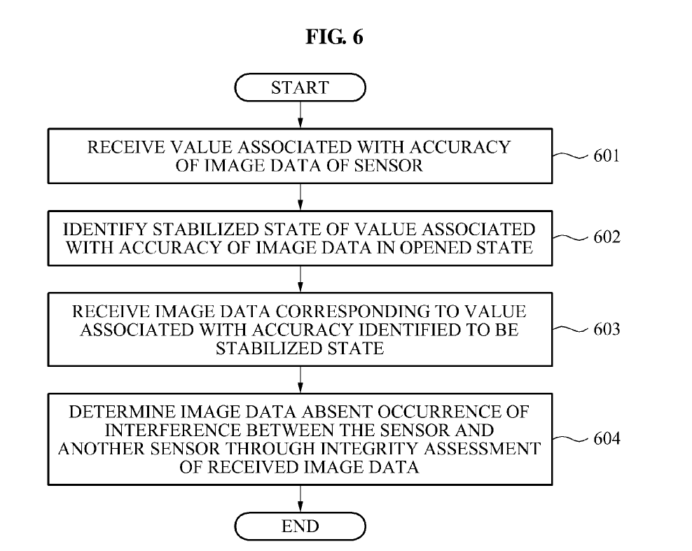

FIG. 6 is a flowchart illustrating a method of determining image data according to another embodiment of the present invention.

In operation 601, an apparatus for determining image data receives, from a sensor, a value associated with an accuracy of image data. More particularly, the apparatus for determining the image data receives the value associated with the accuracy of the image data including a resolution of the image data, a frequency at which the image data is obtained, and the like, at predetermined intervals.

The apparatus for determining the image data receives the value associated with the accuracy of the image data so as to verify whether the image data is a stabilized state because a predetermined period of time is required until the image data reaches the stabilized state when a state of the sensor changes from a blocked state to an opened state. Also, the period of time in which the image data reaches the stabilized state may differ based on the plurality of sensors.

In operation 602, the apparatus for determining the image data evaluates a state change resulting from blocking or opening of the sensor, and identifies the stabilized state of the value associated with the accuracy of the image data in the opened state. In particular, the apparatus for determining the image data recognizes a destabilized state of the image data using a value associated with an accuracy of image data continuously received from the sensor, and using a value associated with an accuracy convergent with a predetermined value of the sensor, identifies the stabilized state of the image data.

Accordingly, the apparatus for determining the image data recognizes an instance in which the destabilized state of the image data changes to the stabilized sate, using the value associated with the accuracy of the image data.

In operation 603, the apparatus for determining the image data receives the image data corresponding to the value associated with the accuracy identified to be the stabilized state.

In operation 604, the apparatus for determining the image data determines the received image data to be image data absent an occurrence of interference between the sensor and another sensor through an integrity assessment of the received image data. Also, the apparatus for determining the image data verifies the integrity of the received image data associated with whether the interference occurs between the sensor and the other sensor. Further, the apparatus for determining the image data verifies the integrity of the received image data, corresponding to a predetermined number of times, and when the predetermined number of times is exceeded, receives differing image data identified to be the stabilized state. In addition, the apparatus for determining the image data verifies the integrity of the received image data, using the re-received image data.

According to the present exemplary embodiment, there is provided an apparatus for capturing image data that minimizes interference between sensors in which a synchronization mechanism is not provided, and efficiently obtains image data having a high accuracy using a plurality of sensors.

According to the present exemplary embodiment, there is provided an apparatus for capturing image data that minimizes interference between sensors in which a synchronization mechanism is not provided, and greatly enhances a performance associated with obtaining image data of the sensors having the minimized interference when compared to a sensor in which interference occurs.

According to the present exemplary embodiment, there is provided an apparatus for capturing image data that verifies a stabilized state of a sensor, verifies an integrity of obtained image data corresponding to the stabilized state, and determines the image data of which the integrity is verified to be meaningful image data available for use.

A method of determining image data, the method comprising: receiving, from a sensor, a value associated with an accuracy of image data of the sensor at predetermined intervals; identifying a stabilized state of the value associated with the accuracy of the image data in an opened state, based on a state change resulting from blocking or opening of the sensor; receiving image data corresponding to the value associated with the accuracy identified to be the stabilized state; and determining the received image data to be image data absent an occurrence of interference between the sensor and another sensor through the integrity assessment of the received image data.

The identifying of the stabilized state of the image data comprises: identifying the stabilized state of the image data corresponding to whether the value associated with the accuracy of the received image data is convergent with a predetermined value of the sensor.

The determining of the received image data to be the image data comprises: verifying an integrity of the received image data associated with whether the interference occurs between the sensor and the other sensor.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for determining image data, the apparatus comprising:
an image data identifier to identify a stabilized state of image data of a sensor in an opened state, based on a state change resulting from blocking or opening of the sensor; and
an image data determiner to receive the image data identified to be the stabilized state, and through an integrity assessment of the image data, determine the image data to be image data absent an occurrence of interference between the sensor and another sensor.

2. The apparatus of claim 1, wherein the image data identifier evaluates a state change associated with a destabilized state or stabilized state of the image data occurring in a process of the sensors being blocked and opened.

3. The apparatus of claim 1, wherein the image data identifier receives, from the sensor, a value associated with an accuracy of the image data, and identifies the stabilized state at predetermined intervals.

4. The apparatus of claim 3, wherein the value associated with the accuracy of the image data comprises at least one of:
a resolution of the image data and a frequency at which the image data is obtained.

5. The apparatus of claim 1, wherein the stabilized state receives the value associated with the accuracy of the image data from the sensor the value associated with the accuracy to be convergent with a predetermined value of the sensor.

6. The apparatus of claim 1, wherein the stabilized state verifies an integrity of the received image data associated with whether the interference between the sensor and the other sensor occurs.

7. The apparatus of claim 1, wherein the image data determiner receives, from the sensor, differing image data identified to be the stabilized state when the integrity of the received image data is not verified.

8. An apparatus for determining image data, the apparatus comprising:
an accuracy value receiver to receive, from a sensor, a value associated with an accuracy of image data of the sensor at predetermined intervals;
an image data identifier to identify a stabilized state of the value associated with the accuracy identified to be the stabilized state;
an image data receiver to receive image data corresponding to the value associated with the accuracy identified to be the stabilized state; and
an image data determiner to determine the received image data to be image data, absent an occurrence of interference between the sensor and another sensor, through an integrity assessment of the received image data.

9. The apparatus of claim 8, wherein the image data identifier identifies the stabilized state of the image data corresponding to whether a value associated with the received image data is convergent with a predetermined value of the sensor.

10. The apparatus of claim 8, wherein the image data determiner verifies the integrity of the received image data associated with whether the interference occurs between the sensor and the other sensor.

11. A method of determining image data, the method comprising:
identifying a stabilized state of a sensor in an opened state, based on a state change resulting from blocking or opening of the sensor; and
receiving the image data identified to be the stabilized state, and through an integrity assessment, determining the received image data to be image data, absent an occurrence of interference between the sensor and the other sensor.

12. The method of claim 11, wherein the identifying of the stabilized state of the image data comprises:
evaluating a state change associated with a destabilized state or stabilized state occurring in a process of the sensor being blocked and opened.

13. The method of claim 11, wherein the identifying of the stabilized state of the image data comprises:
receiving, from the sensor, a value associated with an accuracy of the image data at predetermined intervals, and identifying the stabilized state of the image data.

14. The method of claim 13, wherein the value associated with the accuracy of the image data comprises at least one of:
a resolution of the image data and a frequency at which the image data is obtained.

15. The method of claim 11, wherein the stabilized state receives, from the sensor, the value associated with the accuracy of the image data for the value associated with the accuracy to be convergent with a predetermined value of the sensor.

16. The method of claim 11, wherein the determining of the received image data to be the image data comprises:
verifying an integrity of the received image data associated with whether the interference occurs between the sensor and the other sensor.

17. The method of claim 11, wherein the determining of the received image data to be image data comprises:
receiving, from the sensor, differing image data identified to be the stabilized state when the integrity of the received image data is not verified.
